(19) United States
(12) Patent Application Publication
(10) Pub. No.: US 2022/0233276 A1
(43) Pub. Date: Jul. 28, 2022

(54) MULTI-LAYERED DENTAL APPLIANCE

(71) Applicant: 3M INNOVATIVE PROPERTIES COMPANY, St. Paul, MN (US)

(72) Inventors: Ta-Hua Yu, Woodbury, MN (US); Timothy J. Hebrink, Scandia, MN (US); Karl J.L. Geisler, St. Paul, MN (US)

(21) Appl. No.: 17/607,091

(22) PCT Filed: Apr. 29, 2020
(86) PCT No.: PCT/IB2020/054051

§ 371 Date: Oct. 28, 2021

Related U.S. Application Data
(60) Provisional application No. 62/843,171, filed on May 3, 2019.

(51) Int. Cl. A61C 7/08; B32B 27/08; B32B 27/36; B32B 7/022

(52) U.S. Cl. CPC A61C 7/08; B32B 27/08; B32B 27/36; B32B 7/022; B32B 2535/00; B32B 2250/40; B32B 2250/24; B32B 2307/308; B32B 2307/546; B32B 2250/05

(57) ABSTRACT

A dental appliance includes a polymeric shell with a plurality of cavities for receiving one or more teeth, including an interior region with a core layer of a first thermoplastic polymer A with a thermal transition temperature of about 70° C. to about 140° C. in and a flexural modulus greater than about 1.3 GPa, and first and second interior layers of a second thermoplastic polymer B with a glass transition temperature of less than about 0° C. and a flexural modulus less than about 1 GPa; and first and second exterior layers of a third thermoplastic polymer C with a thermal transition temperature of about 70° C. to about 140° C. and a flexural modulus greater than about 1.3 GPa. Interfacial adhesion between any of the adjacent layers in the polymeric shell is greater than about 150 grams per inch.

### BACKGROUND

Orthodontic treatments involve repositioning misaligned teeth and improving bite configurations for improved cosmetic appearance and dental function. Repositioning teeth is accomplished by applying controlled forces to the teeth of a patient over an extended treatment time period.

Teeth may be repositioned by placing a dental appliance such as a polymeric incremental position adjustment appliance, generally referred to as an orthodontic aligner or an orthodontic aligner tray, over the teeth of the patient. The orthodontic alignment tray includes a polymeric shell with a plurality of cavities configured for receiving one or more teeth of the patient. The individual cavities in the polymeric shell are shaped to exert force on one or more teeth to resiliently and incrementally reposition selected teeth or groups of teeth in the upper or lower jaw. A series of orthodontic aligner trays are provided for wear by a patient sequentially and alternatingly during each stage of the orthodontic treatment to gradually reposition teeth from misaligned tooth arrangement to a successive more aligned tooth arrangement until a desired tooth alignment condition is ultimately achieved. Once the desired alignment condition is achieved, an aligner tray, or a series of aligner trays, may be used periodically or continuously in the mouth of the patient to maintain tooth alignment. In addition, orthodontic retainer trays may be used for an extended time period to maintain tooth alignment following the initial orthodontic treatment.

A stage of an orthodontic treatment may require that a polymeric orthodontic retainer or aligner tray remain in the mouth of the patient for up to 22 hours a day, over an extended treatment time period of days, weeks or even months.

### SUMMARY

The present disclosure is directed to orthodontic dental appliances configured to move or retain the position of teeth in an upper or lower jaw of a patient such as, for example, an orthodontic aligner tray or a retainer tray. An orthodontic dental appliance made from a relatively stiff polymeric material with a high flexural modulus selected to effectively exert a stable and consistent repositioning force against the teeth of a patient such as, for example, polyesters and polycarbonates, can cause discomfort when the dental appliance repeatedly contacts oral tissues or the tongue of a patient over an extended treatment time. These high modulus polymeric materials can also have poor stress retention behavior to provide a desired level of force persistence performance.

A rubbery elastomer has excellent stress retention behavior, in many cases may be too soft to be used alone in a dental appliance to effectively move teeth into a desired alignment condition in a reasonably short treatment time.

In addition, the warm and moist environment in the mouth can cause the polymeric materials in the dental appliance to absorb moisture and swell, which can compromise the mechanical tooth-repositioning properties of the dental appliance. These compromised mechanical properties can reduce tooth repositioning efficiency and undesirably extend the treatment time required to active a desired tooth alignment condition. Further, in some cases repeated contact of the exposed surfaces of the dental appliance against the teeth of the patient can prematurely abrade the exposed surfaces of the dental appliance and cause discomfort.

Dental appliances such as orthodontic aligner and retainer trays can be manufactured by thermoforming a polymeric film to provide a plurality of tooth-retaining cavities therein. In some cases the thermoforming process can thin regions of a relatively rigid polymeric film selected to efficiently apply tooth repositioning force over a desired treatment time. This undesirable thinning can cause localized cracking of the thermoformed dental appliance when the patient repeatedly places the dental appliance over the teeth.

In general, the present disclosure is directed to a multi-layered dental appliance such as, for example, an orthodontic aligner tray or retainer tray, that includes multiple layers of high flexural modulus and low flexural modulus polymeric materials to improve patient comfort while maintaining an acceptable level of force persistence. The combination of thermoplastic polymers in the dental appliance is also selected to provide other beneficial properties such as, for example, good stain resistance, low optical haze, and good mold release properties after the dental appliance is thermally formed from a multilayered polymeric film.

In various embodiments, the dental appliance includes at least 5 polymeric layers, with softer polymeric interior layers disposed between a harder polymeric core layer and two harder polymeric outer layers. The hard core layer can enhance dimensional stability, while the softer middle layers positioned close to the outer skin layers can improve patient comfort and strain recovery.

In various embodiments, the soft polymeric interior layers have a flexural modulus lower than about 1 GPa, a glass transition temperature of less than about 0° C., and a vicat softening temperature of greater than 65° C. In various embodiments, the hard polymer core layer and the outer layers have a flexural modulus greater than 1.3 GPa and a thermal transition temperature in the range of about 70° C. to about 145° C. In various embodiments, the multilayered laminate dental appliance has an effective flexural modulus in the range of about 0.8 GPa to about 1.5 GPa, as well as excellent interfacial adhesion of greater than about 150 grams per inch (6 grams per mm).

In some embodiments, the multilayered dental appliance is transparent or translucent, and has enhanced crack resistance and force persistence, good staining resistance, improved patient comfort and improved dimensional stability.

In one aspect, the present disclosure is directed to a dental appliance for positioning a patient's teeth, which includes a polymeric shell with a plurality of cavities for receiving one or more teeth. The polymeric shell includes an interior region with at least 3 alternating layers: a core layer with a first major surface and a second major surface, wherein the core layer includes a first thermoplastic polymer A with a thermal transition temperature of about 70° C. to about 140° C. and a flexural modulus greater than about 1.3 GPa; a first interior layer adjacent to the first major surface of the core layer; and a second interior layer adjacent to the second major surface of the core layer; wherein the first interior layer and the second interior layer, which may be the same or different, include a second thermoplastic polymer B different from the first thermoplastic polymer A, wherein the second thermoplastic polymer B has a glass transition temperature of less than about 0° C. and a flexural modulus less than about 1 GPa. The polymeric shell further includes an exterior region, including: a first exterior layer on a first side of the interior region, and a second exterior layer on a second side of the interior region, wherein the first exterior layer and the second exterior layer, which may be the same or different, include a third thermoplastic polymer C, which may be the same or different than the first thermoplastic polymer A, with a thermal transition temperature of about 70° C. to about 140° C. and a flexural modulus greater than about 1.3 GPa. Interfacial adhesion between any of the adjacent layers in the polymeric shell is greater than about 150 grams per inch (6 grams per mm).

In another aspect, the present disclosure is directed to a method of making a dental appliance by forming a plurality of tooth-retaining cavities in a multilayered polymeric film. The multilayered polymeric film includes an interior region with at least 3 alternating layers, wherein the interior region includes: a core layer with a first major surface and a second major surface, wherein the core layer includes a first thermoplastic polymer A with a thermal transition temperature of about 70° C. to about 140° C. and a flexural modulus greater than about 1.3 GPa; a first interior layer adjacent to the first major surface of the core layer; and a second interior layer adjacent to the second major surface of the core layer; wherein the first interior layer and the second interior layer, which may be the same or different, include a second thermoplastic polymer B different from the first thermoplastic polymer A, wherein the second thermoplastic polymer B has a thermal glass temperature of less than about 0° C. and a flexural modulus less than about 1 GPa. The multilayered polymeric film further includes an exterior region including a first exterior layer on a first side of the interior region, and a second exterior layer on a second side of the interior region, wherein the first exterior layer and the second exterior layer, which may be the same or different, include a third thermoplastic polymer C, which may be the same or different than the first thermoplastic polymer A, with a thermal transition temperature of about 70° C. to about 140° C. and a flexural modulus greater than about 1.3 GPa. Interfacial adhesion between any of the adjacent layers in the multilayer film is greater than about 150 grams per inch (6 grams per mm).

In another aspect, the present disclosure is directed to a method of orthodontic treatment, which includes positioning a dental appliance around one or more teeth, wherein. The dental appliance includes a polymeric shell with a first major surface having a plurality of cavities for receiving one or more teeth, wherein the cavities are shaped to cover at least some of a patient's teeth and apply a corrective force thereto. The polymeric shell includes an interior region with at least 3 alternating layers, wherein the interior region includes: a core layer with a first major surface and a second major surface, wherein the core layer comprises a first thermoplastic polymer A with a thermal transition temperature of about 70° C. to about 140° C. and a flexural modulus greater than about 1.3 GPa; a first interior layer adjacent to the first major surface of the core layer; and a second interior layer adjacent to the second major surface of the core layer; wherein the first interior layer and the second interior layer, which may be the same or different, include a second thermoplastic polymer B different from the first thermoplastic polymer A, wherein the second thermoplastic polymer B has a glass transition temperature of less than about 0° C. and a flexural modulus less than about 1 GPa. The polymeric shell further includes an exterior region, including a first exterior layer on a first side of the interior region, and second exterior layer on a second side of the interior region, wherein the first exterior layer and the second exterior layer, which may be the same or different, include a third thermoplastic polymer C, which may be the same or different than the first thermoplastic polymer A, with a thermal transition temperature of about 70° C. to about 140° C. and a flexural modulus greater than about 1.3 GPa. Interfacial adhesion between any of the adjacent layers in the polymeric shell is greater than about 150 grams per inch (6 grams per mm).

In another aspect, the present disclosure is directed to a method of making a dental appliance. The method includes coextruding a first polymeric composition to form a first layer, a second polymeric composition to form a second layer, a third polymeric composition to form a third layer, a fourth polymeric composition to form a fourth layer, and a fifth polymeric composition to form a fifth layer of a multilayered polymeric film, wherein the third layer is between the second and the fourth layers of the multilayered polymeric film and the first and the second layers are on an external major surface of the second and the fourth layers of the polymeric film, respectively. The first, second and third polymeric compositions include a first thermoplastic polymer A with a thermal transition temperature of about 70° C. to about 140° C. and a flexural modulus greater than about 1.3 GPa; and the second and the fourth compositions include a second thermoplastic polymer B with a glass transition temperature of less than about 0° C. and a flexural modulus less than about 1 GPa. Interfacial adhesion between any of the adjacent layers in the multilayered polymeric film is greater than about 150 grams per inch (6 grams per mm). The multilayered polymeric film is formed with an arrangement of cavities configured to receive one or more teeth to create the dental appliance.

In another aspect, the present disclosure is directed to a dental appliance for positioning a patient's teeth, which includes a polymeric shell having a plurality of cavities for receiving one or more teeth. The polymeric shell includes at least 5 alternating polymeric layers AB, wherein the shell has: a core layer and a first and the second external surface layers, which may be the same or different, each including at least one layer of a thermoplastic polymer A with a thermal transition temperature of about 70° C. to about 140° C. and a flexural modulus greater than about 1.3 GPa; and an arrangement of internal layers between the core layer and the first and the second internal layers, wherein the internal core layers, which may be the same or different, each include at least one layer of a thermoplastic polymer B, and the thermoplastic polymer B is different from the thermoplastic polymer A, wherein the thermoplastic polymer B has a glass transition temperature of less than about 0° C. and a flexural modulus less than about 1 GPa. Interfacial adhesion between any of the adjacent layers in the polymeric shell is greater than about 150 grams per inch (6 grams per mm).

In another aspect, the present disclosure is directed to a dental appliance for positioning a patient's teeth, which includes a plurality of cavities for receiving one or more teeth. The polymeric shell includes a core region, with: a core layer with a first major surface and a second major surface, wherein the core layer includes at least one layer of a thermoplastic polymer A with a thermal transition temperature of about 70° C. to about 140° C. and a flexural modulus greater than about 1.3 GPa; and an internal layer on the first major surface and the second major surface of the core layer, wherein the internal layers, which may be the same or different, each include at least one layer of a thermoplastic polymer B different from the thermoplastic polymer A, and wherein the thermoplastic polymer B has a glass transition temperature of less than about 0° C. and a flexural modulus less than about 1 GPa. The polymeric shell further includes external surface layers on each side of the core region, wherein the external surface layers, which may be the same or different, each including at least one layer of a thermoplastic polymer C, different from the thermoplastic polymer A, wherein the thermoplastic polymer C has a thermal transition temperature of about 70° C. to about 140° C. and a flexural modulus greater than about 1.3 GPa. Interfacial adhesion between any of the adjacent layers in the polymeric shell is greater than about 150 grams per inch (6 grams per mm).

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic overhead perspective view of an embodiment of a multilayered dental appliance.

FIG. 2 is a schematic, cross-sectional view of an embodiment of a multilayered dental appliance of FIG. 1.

FIG. 3 is a schematic, cross-sectional view of an embodiment of a multilayered dental appliance of FIG. 1.

FIG. 4 is a schematic overhead perspective view of a method for using a dental alignment tray by placing the dental alignment tray to overlie teeth.

FIG. 5 is a perspective representation of the results of the Folding Crazing Resistance test detailed in the Example section of the present disclosure.

Like symbols in the drawings indicate like elements.

### DETAILED DESCRIPTION

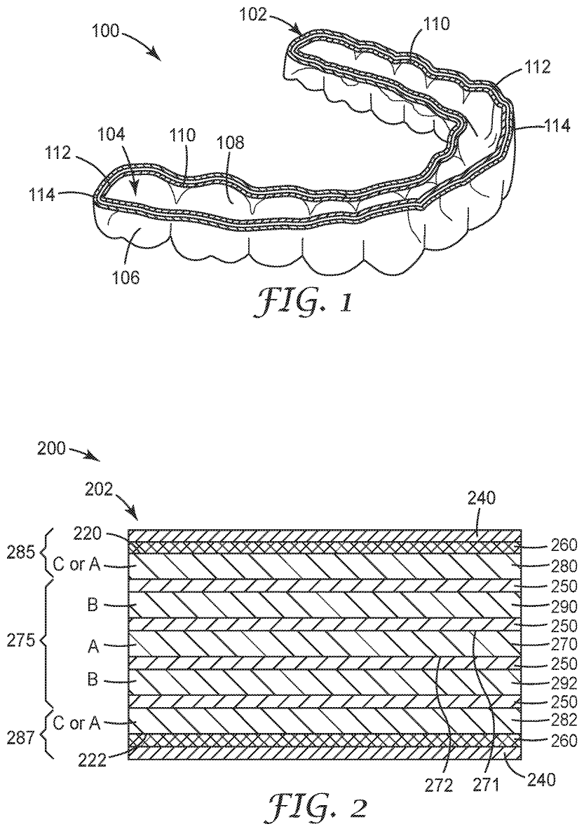

A dental appliance such as an orthodontic appliance 100 shown in FIG. 1, which is also referred to herein as an orthodontic aligner tray, includes a thin polymeric shell 102 having a plurality of cavities 104 shaped to receive one or more teeth in the upper or lower jaw of a patient. In some embodiments, in an orthodontic aligner tray the cavities 104 are shaped and configured to apply force to the teeth of the patient to resiliently reposition one or more teeth from one tooth arrangement to a successive tooth arrangement. In the case of a retainer tray, the cavities 104 are shaped and configured to receive and maintain the position of one or more teeth that have previously been aligned.

The shell 102 of the orthodontic appliance 100 is an arrangement of layers of elastic polymeric materials that generally conforms to a patient's teeth, and may be transparent, translucent, or opaque. The polymeric materials are selected to provide maintain a sufficient and substantially constant stress profile during a desired treatment time, and to provide a relatively constant tooth repositioning force over the treatment time to maintain or improve the tooth repositioning efficiency of the shell 102.

In the embodiment of FIG. 1, an arrangement of one or more polymeric layers 114, which also may be referred to herein as skin layers, forms an external surface 106 of the shell 102. The external surface 106 contacts the tongue and cheeks of a patient. An arrangement of one or more polymeric layers 110, which may also be referred to herein as skin layers, forms an internal surface 108 of the shell 102. The internal surface 108 contacts the teeth of a patient. An arrangement of internal polymeric layers 112 resides between the polymeric layers 110 and 112.

A schematic cross-sectional view of an embodiment of a dental appliance 200 is shown in FIG. 2, which includes a polymeric shell 202 with a multilayered polymeric structure. The polymeric shell 202 includes at least 3, or at least 5, or at least 7, alternating layers of thermoplastic polymers AB. The polymeric shell 202 includes an interior region 275 including a core layer 270 with a first major surface 271 and a second major surface 272. The interior region 275 further includes interior layers 290, 292 arranged on the first major surface 271 and the second major surface 272, respectively, of the core layer 270. The polymeric shell further includes exterior regions 285, 287 on opposed sides of the interior region 275. The exterior regions, which may also be referred to herein as skin layers, include first and second external surface layers 280, 282, which face outwardly on the exposed surfaces of the polymeric shell 202.

In some embodiments, the polymeric shell 202 has an overall flexural modulus necessary to move the teeth of a patient. In some embodiments, the polymeric shell 102 has an overall flexural modulus of greater than about 0.5 GPa, or about 0.8 GPa to about 1.5 GPa, or about 1.0 GPa to about 1.3 GPa.

In some embodiments, the interfacial adhesion between any of the adjacent layers in the polymeric shell 202 is greater than about 150 grams per inch (6 grams per mm), or greater than about 500 grams per inch (20 grams per mm).

In the embodiment of FIG. 2, the core layer 270 includes one or more layers of a thermoplastic polymer A with a thermal transition temperature of about 70° C. to about 140° C., or about 80° C. to about 120° C., and a flexural modulus greater than about 1.3 GPa, or greater than about 1.5 GPa, or greater than about 2 GPa. In some embodiments, the thermoplastic polymer A has an elongation at break of greater than about 100%. As used in the present disclosure, a thermal transition temperature is any one of glass transition (Tg), melting temperature (Tm), and Vicat softening temperature. Methods for determining these values are set out in the Examples below.

For example, the thermoplastic polymer A may include a polyester or a copolyester, which may include linear, branched or cyclic segments on the polymer backbone. Suitable polyesters and copolyesters may include ethylene glycol on the polymer backbone, or be free of ethylene glycol. Suitable polyesters include, but are not limited to, copolyesters with no ethylene glycol available under the trade designation TRITAN from Eastman Chemical, Kingsport, Tenn., polyethylene terephtlialate (PET), polyethylene terephthalate glycol (PETg), polycyclohexylenedimethylene terephtlialate (PCT), polycyclohexylenedimethylene terephthalate glycol (PCTg), poly(1,4 cyclohexylenedimethylene) terephthalate. (PCTA), polycarbonate (PC), and mixtures and combinations thereof. Suitable PETg resins, which contain no ethylene glycol on the polymer backbone, can be obtained from various commercial suppliers such as, for example, Eastman Chemical, Kingsport, Tenn.; SK Chemicals, Irvine, Calif.; DowDuPont, Midland, Mich.; Pacur, Oshkosh, \VI; and Scheu Dental Tech, Iserlohn, Germany. For example, EASTAR GN071 PETg resins and PCTg VM318 resins from Eastman Chemical have been found to be suitable.

In one embodiment, the first and second external surface layers 280, 282, which may be the same or different, each include one or more layers of the thermoplastic polymer A utilized in the core layer 270.

In another embodiment, the first and the second external surface layers 280, 282 may include at one or more layers of a thermoplastic polymer C, different from the thermoplastic polymer A, wherein the thermoplastic polymer C has a thermal transition temperature of about 70° C. to about 140° C., or about 80° C. to about 120° C., and a flexural modulus greater than about 1.3 GPa, or greater than about 1.5 GPa, or greater than about 2 GPa. In some embodiments, the thermoplastic polymer C has an elongation at break of greater than about 100% or even greater than 150%.

For example, in some embodiments the thermoplastic polymer C may include a polyester or a copolyester, which may be linear, branched, or cyclic. Suitable polyesters include, but are not limited to, copolyesters available under the trade designation TRITAN from Eastman Chemical, Kingsport, Tenn., polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedimethylene) terephthalate (PCTA), polycarbonate (PC), and mixtures and combinations thereof. Suitable PETg and PCTg resins can be obtained from various commercial suppliers such as, for example, Eastman Chemical, Kingsport, Tenn.; SK Chemicals, Irvine, Calif.; DowDuPont, Midland, Mich.; Pacur, Oshkosh, \VI; and Scheu Dental Tech, Iserlohn, Germany. For example, EASTAR GN071 PETg resins and PCTg VM318 resins from Eastman Chemical have been found to be suitable.

The interior layers 290, 292, which may be the same or different, each include one or more layers of a thermoplastic polymer B, different from the thermoplastic polymer A, wherein the thermoplastic polymer B has a glass transition temperature of less than about 0° C., a vicat softening temperature of greater than 65° C., or greater than about 100° C., inherent viscosity greater than 1 cc/gm, and a flexural modulus less than about 1 GPa, or less than about 0.8 GPa, or less than about 0.25 GPa, or less than 0.1 GPa (i.e., typically having a modulus alone insufficient to move teeth absent the presence of layer(s) A and/or C). In some embodiments, the thermoplastic polymers B have a melting temperature of greater than about 70° C., or greater than about 100° C., greater than about 150° C., or greater than about 200° C. In some embodiments, the thermoplastic polymers B have an elongation at break of greater than about 300%, or greater than about 400%. In some embodiments, the ratio of elongation at break of polymers B to either of polymers A and C is no greater than about 5, or no greater than about 3.

In various embodiments, which are not intended to be limiting, the thermoplastic polymers B in the interior layers 290, 292 are independently chosen from copolyester ether elastomers, copolymers of ethylene acrylates and methacrylates, ethylene methyl-acrylates, ethylene ethyl-acrylates, ethylene butyl acrylates, maleic anhydride modified polyolefin copolymers, methacrylic acid modified polyolefin copolymers, ethylene vinyl alcohol (EVA) polymers, styrenic block copolymers, ethylene propylene copolymers, and thermoplastic polyurethanes (TPU).

In some embodiments, the thermoplastic polymers B are chosen from copolyester ether elastomers, which may be linear, branched, or cyclic. Suitable examples include materials available under the trade designation NEOSTAR such as, for example, FN007, and ECDEL from Eastman Chemical, ARNITEL co-polyester elastomer from DSM Engineering Materials (Troy, Mich.), RITEFLEX polyester elastomer from Celanese Corporation (Irvine Tex.), HYTREL polyester elastomer from DowDuPont, copolymers of ethylene and methyl acrylate available from DowDuPont, Midland, Mich. under the trade designation EINALOY, ethylene vinyl alcohol (EVA) polymers, and the like.

In various embodiments, suitable polymers B for the interior layers 290, 292 of the polymeric shell 202 have a flexural modulus less than about 0.24 GPa, or less than about 0.12 GPa.

In one embodiment, one or more layers of a TPU described in U.S. Provisional Patent Application No. 62/843,143, which is copending with the present application, assigned to the present assignee, and incorporated by reference herein in its entirety, were used in the multilayered dental appliances described above as the thermoplastic polymer B. This TPU includes monomeric units derived from a polyisocyanate, at least one dimer fatty diol, and an optional hydroxyl-functional chain extender. In some embodiments, the TPU polymer includes hard microdomains formed by reaction between the polyisocyanate and the optional chain extender, as well as soft microdomains formed by reactions between the polyisocyanate and the dimer fatty diol.

The dimer fatty diols used to form the TPU are derived from dimer fatty acids, which are dimerization products of mono or polyunsaturated fatty acids and/or esters thereof. The related term trimer fatty acid similarly refers to trimerization products of mono- or polyunsaturated fatty acids and/or esters thereof.

Dimer fatty acids are described in, for example, T. E. Breuer, Dimer Acids, in J. I. Kroschwitz (ed.), Kirk-Othmer Encyclopedia of Chemical Technology, 4th Ed., Wily, N.Y., 1993, Vol. 8, pp. 223-237. The dimer fatty acids are prepared by polymerizing fatty acids under pressure, and then removing most of the unreacted fatty add starting materials by distillation. The final product usually contains some small amounts of mono fatty acid and trimer fatty acids but is mostly made up of dimer fatty acids. The resultant product can be prepared with various proportions of the different fatty acids as desired.

The dimer fatty acids used to form the dimer fatty diols are derived from the dimerization products of C10 to C30 fatty acids, C12 to C24 fatty acids, C14 to C22 fatty acids, C16 to C20 fatty acids, and especially CIS fatty acids. Thus, the resulting dimer fatty acids include from 20 to 60, 24 to 48, 28 to 44, 32 to 40, and especially 36 carbon atoms.

The fatty acids used to form the dimer fatty diols may be selected from linear, branched, or cyclic fatty acids, which may be saturated or unsaturated. The fatty acids may be selected from fatty acids having either a cis/trans configuration and may have one or more than one unsaturated double bond. In some embodiments, the fatty acids used are linear monounsaturated fatty acids. The fatty acids may be hydrogenated or non-hydrogenated, and in some cases a hydrogenated dimer fatty residue may have better oxidative or thermal stability which may be desirable in a polyurethane.

In some embodiments, suitable dimer fatty acids can be the dimerization products of fatty acids including, but not limited to, oleic acid, linoleic acid, linolenic acid, palmitoleic acid, or elaidic add. In particular, suitable dimer fatty acids are derived from oleic acid. The dimer fatty acids may be dimerization products of unsaturated fatty acid mixtures obtained from the hydrolysis of natural fats and oils, sunflower oil, soybean oil, olive oil, rapeseed oil, cottonseed oil, or tall oil.

In various embodiments, the molecular weight (weight average) of the dimer fatty acids used to make the TPU polymer described herein is 450 to 690, or 500 to 640, or 530 to 610, or 550 to 590.

In addition to the dimer fatty acids, dimerization usually results in varying amounts of frillier fatty acids, oligomeric fatty acids, and residues of monomeric fatty acids, or esters thereof, being present. In various embodiments, the dimer fatty acid used to make the dinner fatty diol should have a relatively low amount of these additional dimerization products, and the dimer fatty acid should have a dimer fatty acid (or dimer) content of greater than 80 wt %, or greater than 85 wt %, or greater than 90 wt %, or greater than 95 wt %, or up to 99 wt %, based on the total weight of polymerized fatty acids and mono fatty acids present.

Any of the above dimer fatty acid may be converted to a dimes fatty diol, and the resulting (linter fatty diol may have the properties of the dimer fatty adds described herein, except that the acid groups in the dimer fatty acid are replaced with hydroxyl groups in the dimer fatty diol. The dimer fatty diol may be hydrogenated or non-hydrogenated.

In some embodiments, which are not intended to be limiting, the dimer fatty diol is derived from a fatty acid with a C18 alkyl chain. In one embodiment, the dimer fatty diol is a C36 diol available from Croda, Inc., New Castle, Del., under the trade designation PRIPOL 2033. One depiction of the structure of PRIPOL 2033 is shown below:

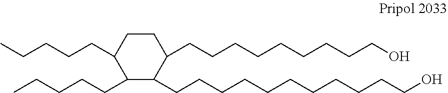 [SMILES: CCCCCC1CCC(CCCCCCCCCO)C(CCCCCCCCCCCO)C1CCCCC]

The polyisocyanate reactant used to make the TPU polymer includes at least one isocyanate with a functionality of at least 2, and in various embodiments may be an aliphatic isocyanate, such as hexamethylene 1,6-diisocyanate or isophorone diisocyanate (IPDI), or an aromatic isocyanate.

In some embodiments, the polyisocyanate is a an aromatic isocyanate, and, suitable examples include, but are not limited to, toluene diisocyanate, m-phenylene diisocyanate, p-phenylene diisocyanate, xylylene diisocyanate, 4,4′-diphenylmethane diisocyanate, hexamethylene diisocyanate, isophorone diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, modified compounds thereof such as uretonimine-modified compounds thereof, and mixtures and combinations thereof.

In one embodiment, the isocyanate component includes 4,4′-diphenylmethane diisocyanate (MDI), or a mixture of NIDI and a uretonimine-modified 4,4-′-diphenylmethane diisocyanate (modified. MDI).

The optional hydroxyl-functional chain extender has two or more active hydrogen groups and in some embodiments includes polyols such as ethylene glycol, diethylene glycol; propylene glycol, 1,4-butylene glycol, 1,5-pentylene glycol, methylpentanediol, isosorbide (and other iso-hexides) 1,6-hexylene glycol, neopentyl glycol, trimethylolpropane, hydroquinone ether alkoxylate, resorcinol ether alkoxylate, glycerol, pentaerythritol, digylcerol, and dextrose; dimer fatty diol; aliphatic polyhydric amines such as ethylenediamine, hexamethylenediamine, and isophorone diamine; aromatic polyhydric amines such as methylene-bis(2-chloroaniline), methylenebis(dipropylaniline), diethyl-toluenediamine, trimethylene glycol di-p-aminobenzoate; alkanolamines such as diethanolamine, triethanolamine, diisopropanolamine, and mixtures and combinations thereof.

In various embodiments the hydroxyl-functional chain extender is a polyol, particularly a diol with an aliphatic linear or branched carbon chain having from 1 to 10, or 3 to 7 carbon atoms. Suitable diols include, but are not limited to, ethylene glycol, propylene glycol, diethylene glycol, propylene glycol, 1,4-butylene glycol, 1,5-pentylene glycol, 1,6 hexylene glycol (1,6 hexane diol), methylpentanediol, isosorbide (and other iso-hexides), and mixtures and combinations thereof. In certain embodiments, one or both of polymers A. and C can comprise (i.e., modified by) 16 mole % to 32 mole % of 2,2,4,4-tetramethyl-1,3-cyclobutanediol.

In some embodiments, the TPU may most conveniently be prepared by a reactive extrusion process in which a polymeric reactive extrusion composition including the polyisocyanate, at least one dimer fatty diol, the optional hydroxyl-functional chain extender, and any other optional components such as crosslinkers, catalysts, and the like are loaded into an extruder and extruded from an appropriate die to form a layer in a multilayered polymeric film. In some embodiments, the multilayered film may later be thermoformed into a dental appliance with tooth-retaining cavities. In another embodiment, the reactive extrusion composition including the TPU may be injected into a mold, which in some cases

Referring again to FIG. 2, the polymeric shell 202 further includes additional optional performance enhancing layers that can be included to improve properties of the shell 202. In various embodiments, which are not intended to be limiting, the performance enhancing layers can be, for example, barrier layers that are resistant to staining and moisture absorption; abrasion-resistant layers, cosmetic layers that may optionally include a colorant, or may include a polymeric material selected to adjust the optical haze or visible light transparency of the polymeric shell 202; tie layers that enhance compatibility or adhesion between layers AB or BC, elastic layers to provide a softer mouth feel for the patient; thermal forming assistant layers to enhance thermoforming, layers to enhance mold release during thermoforming, and the like.

The performance enhancing layers may include a wide variety of polymers selected to provide a particular performance benefit, but the polymers in the performance enhancing layers are generally selected from materials that are softer and more elastic than the polymers ABC. In various embodiments, which are not intended to be limiting, the performance enhancing layers include thermoplastic polyurethanes (TPU) and olefins.

In some non-limiting examples, the olefins in the performance enhancing layers are chosen from polyethylene (PE), polypropylene (PP), polymethylpentene (PMP), cyclic olefins (COP), copolyolefins with moieties chosen from ethylene, propylene, butene, pentene, hexene, octene, C2-C20 hydrocarbon monomers with polymerizable double bonds, and mixtures and combinations thereof; and olefin hybrids chosen from olefin/anhydride, olefin/acid, olefin/styrene, olefin/acrylate, and mixtures and combinations thereof.

For example, in the embodiment of FIG. 2, the polymeric shell 202 includes an optional moisture barrier layer 240 on each external surface, which can prevent moisture intrusion into the underlying polymeric layers and maintain for the shell 202 a substantially constant stress profile during a treatment time. The polymeric shell 202 further includes tie or thermoforming assist layers 250, which can be the same or different, between individual layers AB or BC. In some embodiments, the tie/thermoforming assist layers 250 can improve compatibility between the polymers in the layers AB or BC as the polymeric shell 202 is formed from a multilayered polymeric film, or reduce delamination between layers AB or BC and improve the durability and crack resistance of the polymeric shell 202 over an extended treatment time. The polymeric shell 202 in FIG. 2 further includes elastic layers 260, which can be the same or different, and can be included to improve the softness or mouth feel of the shell 202. In the embodiment of FIG. 2, the elastic layers 260 are located proximal the major surfaces 220, 222 of the shell 202.

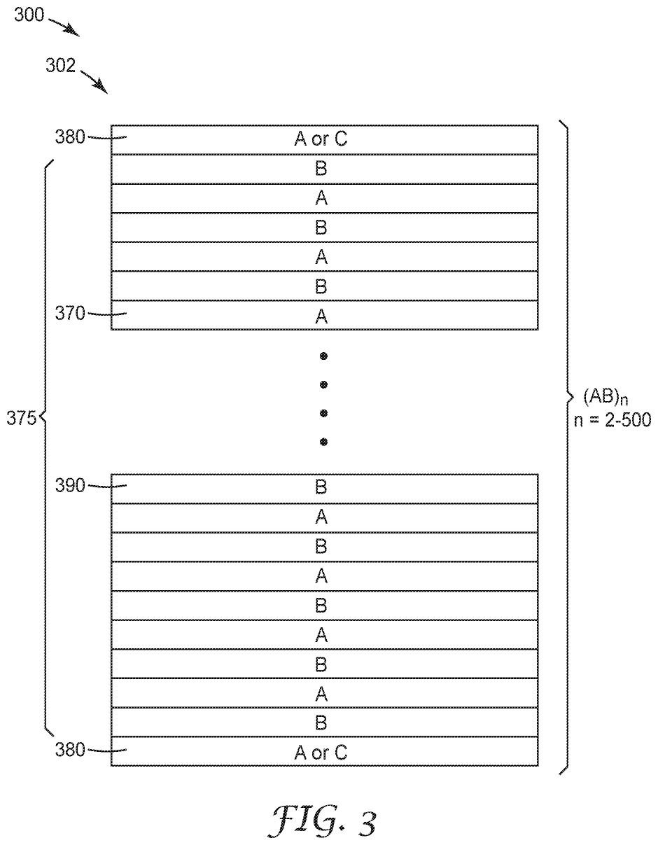

A schematic cross-sectional view of another embodiment of a dental appliance 300 is shown in FIG. 3, which includes a polymeric shell 302 with an interior region 375 having a multilayered polymeric structure (AB)ₙ, wherein n 2 to about 500, or about 5 to about 200, or about 10 to about 100. The layers AB include core layers 370, 390 of the thermoplastic polymers A and B discussed above with respect to FIG. 2. The external layers 380 of the polymeric shell 302 can include one or more layers of either of the thermoplastic polymers A or C discussed above.

Referring again to FIG. 1, in some embodiments, the polymeric shell 102 is formed from substantially transparent polymeric materials. In this application the term substantially transparent refers to materials that pass light in the wavelength region sensitive to the human eye (about 400 mm to about 750 nm) while rejecting light in other regions of the electromagnetic spectrum. In some embodiments, the reflective edge of the polymeric materials selected for the shell 102 should be above about 750 nm, just out of the sensitivity of the human eye.

In some embodiments, any or all of the layers of the polymeric shell 102 can optionally include dyes or pigments to provide a desired color that may be, for example, decorative or selected to improve the appearance of the teeth of the patient.

The orthodontic appliance 100 may be made using a wide variety of techniques. In one embodiment, a suitable configuration of tooth (or teeth)-retaining cavities are formed in a substantially flat sheet of a multilayered polymeric film that includes layers of polymeric material arranged like the configurations discussed described above with respect to FIGS. 1-3. In some embodiments, the multilayered polymeric film may be formed in a dispersion and cast into a film or applied on a mold with tooth-receiving cavities. In some embodiments, the multilayered polymeric film may be prepared by extrusion of multiple polymeric layer materials through an appropriate die to form the film. In some embodiments, a reactive extrusion process may be used in which one or more polymeric reaction products are loaded into the extruder to form one or more layers during the extrusion procedure.

In some embodiments, the multilayer polymeric film may later be thermoformed into a dental appliance with tooth-retaining cavities or injected into a mold including tooth-retaining cavities. The tooth-retaining cavities may be formed by any suitable technique, including thermoforming, laser processing, chemical or physical etching, and combinations thereof, but thermoforming has been found to provide good results and excellent efficiency. In some embodiments, the multilayered polymeric film is heated prior to forming the tooth-retaining, cavities, or a surface thereof may optionally be chemically treated such as, for example, by etching, or mechanically embossed by contacting the surface with a tool, prior to or after forming the cavities.

The multilayered polymeric film, the formed dental appliance, or both, may optionally be crosslinked with radiation chosen from ebeam, gamma, UV, and mixtures and combinations thereof.

In various embodiments, particularly those include thermoplastic elastomers as the core layer (C), the dental appliance is substantially optically clear. Some embodiments have a light transmission of at least about 50%. Some embodiments have a light transmission of at least about 75%. Some embodiments have a haze of no greater than 10%. Some embodiments have a haze of no greater than 5%. Some embodiments have a haze of no greater than 2.5%. Both the light transmission and the haze of the adhesive article can be determined using, for example, ASTM D1003-95. The haze of dental appliance of certain presently preferred embodiments is less than 10% and the light transmission of dental appliance is greater than 80%.

In various embodiments, the multilayered polymeric film used to form the dental appliance has a thickness of less than about 1 mm, or less than about 0.8 mm, or less than about 0.5 mm.

In some embodiments, the multilayered polymeric film may be manufactured in a roll-to-roll manufacturing process, and may optionally be wound into a roll until further converting operations are required to form one or more dental appliances.

The orthodontic article 100 can exhibit a percent loss of relaxation modulus of 40% or less as determined by Dynamic Mechanical Analysis (DMA). The DMA procedure is described in detail in the Examples below. The loss is determined by comparing the initial relaxation modulus to the (e.g., 4 hour) relaxation modulus at 37° C. and 1% strain. It was discovered that orthodontic articles according to at least certain embodiments of the present disclosure exhibit a smaller loss in relaxation modulus than articles made of different materials. Preferably, an orthodontic article exhibits loss of relaxation modulus after hydration of 40% or less, 38% or less, 36% or less, 34% or even 32% or less. In some embodiments, the loss of relaxation modulus is at least 15%, 20%, or 25% or greater.

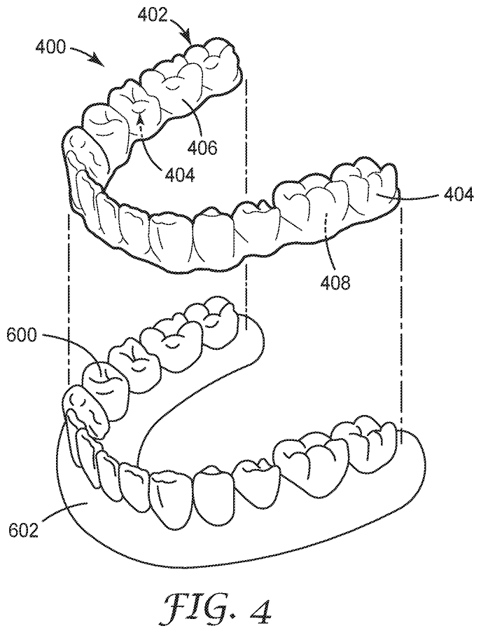

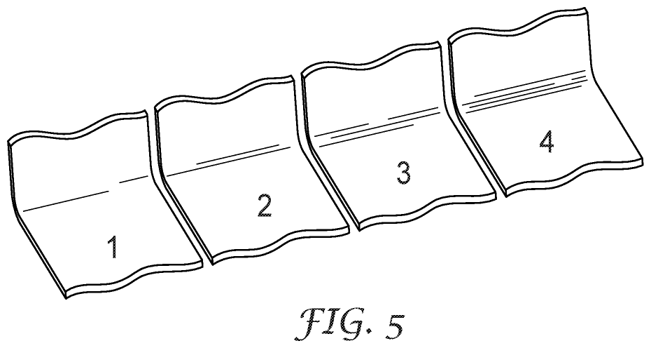

Referring now to FIG. 4, a shell 402 of an orthodontic appliance 400 includes an outer surface 406 and an inner surface 408 with cavities 404 that generally conform to one or more of a patient's teeth 600. In some embodiments, the cavities 404 are slightly out of alignment with the patient's initial tooth configuration, and in other embodiments the cavities 404 conform to the teeth of the patient to maintain a desired tooth configuration. In some embodiments, the shell 402 may be one of a group or a series of shells having substantially the same shape or mold, or incrementally different shapes, but which are formed from different polymeric materials, or different layers of polymeric materials, selected to provide a desired stiffness or resilience as needed to move the teeth of the patient. In some embodiments, the shell 402 may be one of a group or a series of shells having substantially the same shape or mold, or incrementally different shapes, but which are formed from the same polymeric materials, selected to provide a desired stiffness or resilience as needed to move the teeth of the patient. In this manner, in one embodiment, a patient or a user may alternately use one of the orthodontic appliances during each treatment stage depending upon the patient's preferred usage time or desired treatment time period for each treatment stage.

No wires or other means may be provided for holding the shell 402 over the teeth 600, but in some embodiments, it may be desirable or necessary to provide individual anchors on teeth with corresponding receptacles or apertures in the shell 402 so that the shell 402 can apply a retentive or other directional orthodontic force on the tooth which would not be possible in the absence of such an anchor.

The shells 402 may be customized, for example, for day time use and night time use, during function or non-function (chewing vs. non-chewing), during social settings (where appearance may be more important) and nonsocial settings (where the aesthetic appearance may not be a significant factor), or based on the patient's desire to accelerate the teeth movement (by optionally using the more stiff appliance for a longer period of time as opposed to the less stiff appliance for each treatment stage).

For example, in one aspect, the patient may be provided with a clear orthodontic appliance that may be primarily used to retain the position of the teeth, and an opaque orthodontic appliance that may be primarily used to move the teeth for each treatment stage. Accordingly, during the daytime, in social settings, or otherwise in an environment where the patient is more acutely aware of the physical appearance, the patient may use the clear appliance. Moreover, during the evening or night time, in non-social settings, or otherwise when in an environment where physical appearance is less important, the patient may use the opaque appliance that is configured to apply a different amount of force or otherwise has a stiffer configuration to accelerate the teeth movement during each treatment stage. This approach may be repeated so that each of the pair of appliances are alternately used during each treatment stage.

Referring again to FIG. 4, an orthodontic treatment system and method of orthodontic treatment includes applying to the teeth of a patient one or more incremental position adjustment appliances, each having substantially the same shape or mold, or incrementally different shapes. The incremental adjustment appliances may each be formed from the same or a different combination of polymeric materials, as needed far each treatment stage of orthodontic treatment. The orthodontic appliances may, be configured to incrementally reposition individual or multiple teeth 600 in an upper or lower jaw 602 of a patient. In some embodiments, the cavities 404 are configured such that selected teeth will be repositioned, while other teeth will be designated as a base or anchor region for holding the repositioning appliance in place as the appliance applies the resilient repositioning three against the tooth or teeth intended to be repositioned.

Placement of the elastic positioner 400 over the teeth 600 applies controlled forces in specific locations to gradually move the teeth into the new configuration. Repetition of this process with successive appliances having different configurations eventually moves the teeth of a patient through a series of intermediate configurations to a final desired configuration.

The devices of the present disclosure will now be further described in the following non-limiting examples.

### EXAMPLES

The following Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, and the like in the Examples and the rest of the specification are provided on the basis of weight. Solvents and other reagents used may be obtained from Sigma-Aldrich Chemical Company (Milwaukee, Wis.) unless otherwise noted.

### Materials

PETg: copolyester from Eastman Chemicals, Kingsport, Tenn., grade: EASTAR GN071
PCTg: copolyester from Eastman Chemicals, grade: VM318
TX1000: copolyester from Eastman Chemicals, brand: TRITANMX710: copolyester from Eastman Chemicals, brand: TRITAN
TX2000: copolyester from Eastman Chemicals, brand: TRITAN
MX730: copolyester from Eastman Chemicals, brand: TRITAN
NEOSTAR: copolyester ether elastomer from Eastman Chemicals, grade: FN007
Ecdel 9967: copolyester ether elastomer from Eastman Chemicals
ELVALOY: copolymer of ethylene and methyl acrylate: from DowDuPont, Midland, Mich., grade: ELVALOY 1609
TPU 65D: thermoplastic polyurethane from Lubrizol, Wickliffe, Ohio, grade PELLETHANE 65D
Texin: thermoplastic polyurethane from Covestro, Pittsburgh, Pa., grade RxT50D
STPE: silicone thermoplastic elastomer copolymer of the type prepared in U.S. Pat. No. 5,214,119 (Leir) et al.) and U.S. Pat. No. 8,765,881 (Hayes et al.)
ADMER: thermoplastic elastomer (TPE) from Mitsui Chemicals America, Rye Brook, N.Y., grade SE810
ZEONOR: thermoplastic cylco olefin polymer (COP) from Zeon Chemicals, Louisville, Ky., grade 1060R

### Properties of Selected Polyesters for Layers ABC

Properties of some of the polymeric materials used in the examples below are shown in Table 1 below.

TABLE 1

| | | | | | | | | | Solubility | | |
|---|---|---|---|---|---|---|---|---|---|---|---|
| | | | | Vicat | | | | | Parameter | Inherent | 2,2,4,4- |
| | | | | Softening | | Flexural | | Elongation | (cal^{1/2} | Viscosity | Tetramethyl-1,3- |
| | Tg | | Tm | Temp. | | Modulus | | at Break | cm^{-3/2}) | (cc/gm) | cyclobutanediol |
| PETg | 80° | C. | N/A | 76° | C. | 2.1 | GPa | 180% | 9.36 | 0.75 | N/A |
| PCTg | 81° | C. | N/A | 79° | C. | 1.8 | GPa | 330% | 8.94 | N/A | N/A |
| TX1000 | 110° | C. | N/A | 110° | C. | 1.55 | GPa | 210% | 9 | 0.724 | 25% |
| MX710 | 110° | C. | N/A | 110° | C. | 1.55 | GPa | 210% | 9 | 0.724 | 25% |
| MX730 | 110° | C. | N/A | N/A | | 1.575 | GPa | 210% | N/A | 0.64 | 30% |
| TX2000 | 120° | C. | N/A | N/A | | 1.59 | GPa | 140% | N/A | 0.65 | 35% |
| TPU 65D | <0° | C. | N/A | 107° | C. | 0.22 | GPa | 450% | N/A | N/A | N/A |
| TEXIN | <0° | C. | N/A | 128° | C. | 0.11 | GPa | 480% | N/A | N/A | N/A |
| NEOSTAR | <0° | C. | 205° C. | 170° | C. | 0.2 | GPa | 400% | 8.9 | 1.2 | N/A |
| ECDEL | <0° | C. | 205° C. | 170° | C. | 0.2 | GPa | 400% | 8.9 | 1.2 | N/A |
| ELVALOY | <0° | C. | 101° C. | 70° | C. | 0.08 | GPa | 740% | 8.7 | N/A | N/A |
| ADMER | <0° | C. | N/A | 40° | C. | <0.1 | GPa | >200% | N/A | N/A | N/A |
| STPE | <0° | C. | N/A | N/A | | <0.1 | GPa | >200% | <8 | N/A | N/A |
| ZEONOR | 100° | C. | N/A | 99° | C. | 2.1 | GPa | 60% | N/A | N/A | N/A |

### Summary of Test Procedures

The following test procedures were used in the examples below.

### Flexural Modulus and Elongation at Break

The flexural modulus was tested according to ASTM D790-17 and tensile properties by ASTM D638-14. The specimen made by die cutting was placed in the grips of a universal testing machine. The stress-strain curve was then utilized to determine the modulus and elongation at break.

### Coffee Stain Color Index

Coffee was used for the stain test. The sample was soaked in the coffee for 72 hours at 37° C. The resulting color change (DE) was measured before and after soaking using an X-Rite Color i7 benchtop spectrophotometer (Grand Rapids, Mich.). If the color change (DE) was larger than 10, the sample was rated as poor (−−). If the color change (DE) was less than 10, the sample was rated as Good (++).

### Crack Resistance

The polymeric shells were tested for crack resistance using a manual operation of putting on and taking off the shells from a three-dimensional (3D) printed tooth mold. The polymeric shell was constantly soaked in water at 37° C. The durability of the polymeric shells was rated based on number of cycles for failure due to cracking. The minimal number of cycles considered acceptable for the Crack Resistance test is 150; greater than 300 cycles is considered good, greater than 400 cycles is considered very good, and greater than 450 cycles is considered excellent.

### Stress Relaxation by Dynamic Mechanical Analyzer (DMA)

DMA 3-point bend rectangular specimens were tested in a TA Instruments Q800 DMA (New Castle, Del.). Samples were preconditioned in water for 24 hours prior to testing. The preconditioned samples were then tested by single cantilever bending in a DMA machine enclosed with an environmental chamber kept at 37° C. and 95% relative humidity. Stress relaxation was monitored after applying 1% strain and strain recovery was measured after the stress was removed. The testing time was about 4 hours. The stress relaxation is determined by comparing the initial relaxation modulus to the 4 hour relaxation modulus at 37° C. and 2% strain.

### Interfacial Adhesion

An X-cut with dimensions 2.5 cm×2.5 cm was gently made to the example film substrate, at least through the skin layer, but not through the core layer. Then, 3M™ Polyester Tape 8403 was applied over the cut and subsequently removed. The interfacial adhesion was visually assessed based on if the skin or middle layer delaminated from the core layer. The interfacial adhesion between the substrate and the 3M Polyester Tape 8430 is about 150 gm/inch. An interfacial adhesion was assigned a result of “fail” if delamination from the tape occurred and thus presumably had an adhesion of lower than 150 gm/inch. An interfacial adhesion was assigned a result of “pass” if no delamination was observed and thus, presumably had an adhesion of greater than 150 gm/inch.

### Folding Crazing Resistance

The film sample was cut into 1 cm wide stripe, hand-folded once, and then bent back to its original position. The folded area was inspected visually for crazing, meaning the network of fine cracks or fold line fractures in the folded region. The tested samples were given a number value result that approximated the number fold line fractures observed for the sample. A lower number is desirable and represents better Folding Crazing Resistance. See FIG. 5 for an illustration representing the Folding Crazing Resistance test results, with fractures increasing from left to right.

### Vicat Softening Temperature

Vicat softening temperature was measured according to ASTM D1525-17.

### Melting Temperature and Glass Transition Temperature

Melting temperature and glass transition temperature were measured by DSC (differential scanning calorimeter) according to ASTM D3418.

### Solubility Parameter

The solubility parameter was estimated according to the group contribution method outlined in Chapter 3 of Sperling, L. H., Introduction to Physical Polymer Science, John Wiley & Sons, Inc.: Hoboken, N.J., 2006.

### Haze and Transmission

Haze and transmission were determined using a HAZE-GARD PLUS meter available from BYK-Gardner Inc., Silver Springs, Md., which was designed to comply with the ASTM D1003-13 standard. The specimen surface is illuminated perpendicularly with the transmitted light, measured with an integrating sphere (0°/diffuse geometry). The spectral sensitivity conforms to CIE standard spectral value function “Y” under illuminant C with a 2° observer.

### Procedure for Thermoforming and Temperature Measurement

The film was formed into an article on a BIOSTAR VI pressure molding machine (Scheu-Dental GmbH, Iserlohn, Germany). To thermoform, a 125 mm diameter piece of film was heated for a specific time and then pulled down over a rigid-polymer model. Maximum temperature of the film was measured using an IR thermometer (FLIR TG165) before pulling down over the rigid-polymer model. The BIOSTAR chamber behind the film was pressurized to 90 psi for 15 seconds of cooling time, after which the chamber was vented to ambient pressure and the formed article and arch model were removed from the instrument and cooled down to room temperature under ambient condition.

### Example 1

A 5-layer CBABC (TX1000/NEOSTAR/TX1000/NEOSTAR/TX1000) film was extruded using a pilot scale coextrusion line equipped with a feedblock and film die. The skin layer (C) extruder was fed with the first rigid resin, TX1000. The skin layer (C) extrusion melt temperature was controlled at 505° F. (262.8° C.). The throughput was 4.3 lbs/hr (1.95 kg/hr). The core layer (A) extruder was also fed with the first rigid resin, 0 TX1000, and the extrusion melt temperature was controlled at 550° F. (288° C.). The core layer extrusion throughput was 11.6 lbs/hr (5.26 kg/hr). The middle layer (B) extruder was fed with a second thermoplastic elastomeric resin, NEOSTAR, and the extrusion temperature was controlled at 470° F. (243.3° C.). The middle layer extrusion throughput was 5.54 lbs/hr (2.51 kg/hr). The extruded sheet was chilled on a cast roll. The overall sheet thickness was controlled at 30 mils (0.76 mm).

The film was then subsequently thermally formed into a dental tray. As summarized in Table 2 below, the resulting dental tray had good modulus properties, good force persistence performance, good crack resistance, good stain resistance and good interfacial adhesion.

### Example 2

A 5-layer CBABC (TX1000/ELVALOY/TX1000/ELVALOY/TX1000) film was extruded using a pilot scale coextrusion line equipped with a feedblock and film die. The skin layer (C) extruder was fed with the first rigid resin, TX1000. The skin layer (C) extrusion melt temperature was controlled at 505° F. (262.8° C.). The throughput was 4.3 lbs/hr (1.95 kg/hr). The core layer (A) extruder was also fed with the first rigid resin, TX1000, and the extrusion melt temperature was controlled at 550° F. (288° C.). The core layer extrusion throughput was 11.6 lbs/hr (5.26 kg/hr). The middle layer (B) extruder was fed with a second thermoplastic elastomeric resin, Elvaloy, and the extrusion temperature was controlled at 460° F. (237.8° C.). The middle layer extrusion throughput was 4.56 lbs/hr (2.07 kg/hr). The extruded sheet was chilled on a cast roll. The overall sheet thickness was controlled at 30 mils (0.76 mm).

The film was then subsequently thermally formed into a dental tray and the performance of the dental tray was summarized in Table 2.

### Example 3

A 5-layer CBABC (0 MX730/ECDEL/0 MX730/ECDEL9967/MX730) film was extruded using a pilot scale coextrusion line equipped with a feedblock and film die. The skin layer (C) extruder was fed with the first rigid resin, MX730. The skin layer (C) extrusion melt temperature was controlled at 524° F. (273.3° C.). The throughput was 4.34 lbs/hr (1.97 kg/hr). The core layer (A) extruder was also fed with the first rigid resin, MX730, and the extrusion melt temperature was controlled at 530° F. (276.7° C.). The core layer extrusion throughput was 13.04 lbs/hr (5.91 kg/hr). The middle layer (B) extruder was fed with a second thermoplastic elastomeric resin, ECDEL, and the extrusion temperature was controlled at 406° F. (207.8° C.). The middle layer extrusion throughput was 4.2 lbs/hr (1.91 kg/hr). The extruded sheet was chilled on a cast roll and had an average haze of 2.5% and transmission of 89%. The overall sheet thickness was controlled at 30 mils (0.76 mm). The film was then subsequently thermal formed into a dental tray and summarized in Table 2.

### Example 4

A 5-layer CBABC (MX710/ECDEL/MX710/ECDEL 9967/MX710) film was extruded using a pilot scale coextrusion line equipped with a feedblock and film die. The skin layer (C) extruder was fed with the first rigid resin, MX710. The skin layer (C) extrusion melt temperature was controlled at 524° F. (273.3° C.). The throughput was 56.34 lbs/hr (25.56 kg/hr). The core layer (A) extruder was also fed with the first rigid resin, MX710, and the extrusion melt temperature was controlled at 547° F. (286.1° C.). The core layer extrusion throughput was 141 lbs/hr (63.96 kg/hr). The middle layer (B) extruder was fed with a second thermoplastic elastomeric resin, ECDEL, and the extrusion temperature was controlled at 414° F. (212.2° C.). The middle layer extrusion throughput was 53.95 lbs/hr (24.47 kg/hr). The extruded sheet was chilled on a cast roll and had an average haze of 1.6% and transmission of 90.3%. The overall sheet thickness was controlled at 25 mils (0.625 mm). The film was then subsequently thermal formed against a flat mold. The maximum thermal forming temperature of the heated film was measured 226° C. by the IR thermometer. The haze of the thermoformed article was determined to be 1.5%

### Comparative Example 1

A single-layer polymeric film with 100% PETg resin was extruded through a film die using a pilot scale extruder at a throughput of 15 lbs/hr (22.7 kg/hr). The extrusion melt temperature was controlled to be 520° F. (271° C.). The extruded sheet thickness was controlled at 30 mils (0.76 mm).

The film was then subsequently thermally formed into a dental tray. As summarized in Table 2 below, the dental tray of single-layer PETg has a high modulus, which might result in patient discomfort upon initial seating on the dental arch.

### Comparative Example 2

A 3-layer ABA (PCTg/TEXIN/PCTg) film was extruded using a pilot scale coextrusion line equipped with a multi-manifold die. Two extruders were used for the skin layer (A) and fed with the first rigid resin, PCTg. The skin layer (A) extrusion melt temperatures were controlled at 520° F. (271° C.). The throughput was kept at 13.7 lbs/hr (6.2 kg/hr) from each extruder. The core layer (A) extruder was fed with a second thermoplastic polyurethane, TEXIN, and the extrusion melt temperature was controlled at 410° F. (210° C.). The core layer extrusion throughput was 13 lbs/hr (5.9 kg/hr). The extruded sheet was chilled on a cast roll. The overall sheet thickness was controlled at 30 mils (0.76 mm).

The film was then thermally formed into a dental tray. As summarized in Table 2, the dental tray of 3-layer film had poor stress relaxation performance.

### Comparative Example 3

A 5-layer CBABC (ZEONOR/ELVALOY/ZEONOR/ELVALOY/ZEONOR) film was extruded using a pilot scale coextrusion line equipped with a multi-manifold die. The skin layer (C) extruder was fed with the first rigid resin, ZEONOR. The skin layer (C) extrusion melt temperature was controlled at 464° F. (240° C.). The throughput was 5 lbs/hr (2.3 kg/hr). The core layer (A) extruder was also fed with the first rigid resin, ZEONOR, and the extrusion melt temperature was controlled at 460° F. (240° C.). The core layer extrusion throughput was 15 lbs/hr (6.8 kg/hr). The middle layer (B) extruder was fed with a second thermoplastic elastomeric resin, ELVALOY, and the extrusion temperature was controlled at 470° F. (243.3° C.). The middle layer extrusion throughput was 32 lbs/hr (14.5 kg/hr). The extruded sheet was chilled on a cast roll. The overall sheet thickness was controlled at 30 mils (0.76 mm).

The film was then subsequently thermal formed into a dental tray. As summarized in Table 2 below, the resulting dental tray had very poor crack resistance.

### Comparative Example 4

A 3-layer ABA (PCTg/STPE/PCTg) film was extruded using a pilot scale coextrusion line equipped with a feedblock and film die. The skin layer (A) extruder was fed with the first rigid resin, PCTg. The skin layer (A) extrusion melt temperature was controlled at 528° F. (275.6° C.). The throughput was 20.5 lbs/hr (9.3 kg/hr). The core layer (B) extruder was fed with a second thermoplastic elastomeric resin, STPE, and the extrusion temperature was controlled at 530° F. (276.7° C.). The core layer extrusion throughput was 10.2 lbs/hr (4.63 kg/hr). The extruded sheet was chilled on a cast roll. The overall sheet thickness was controlled at 30 mils (0.76 mm).

The film was then thermally formed into a dental tray. As summarized in Table 2 below, the resulting dental tray had very poor interfacial adhesion.

### Comparative Example 5

A 5-layer CBABC (TX1000/ADMER/TX1000/ADMER/TX1000) film was extruded using a pilot scale coextrusion line equipped with a feedblock and film die. The skin layer (C) extruder was fed with the first rigid resin, TX1000. The skin layer (C) extrusion melt temperature was controlled at 505° F. (262.8° C.). The throughput was 4.3 lbs/hr (1.95 kg/hr). The core layer (A) extruder was also fed with the first rigid resin, TX1000, and the extrusion melt temperature was controlled at 550° F. (288° C.). The core layer extrusion throughput was 11.6 lbs/hr (5.26 kg/hr). The middle layer (B) extruder was fed with a second thermoplastic elastomeric resin, ADMER, and the extrusion temperature was controlled at 490° F. (254.4° C.). The middle layer extrusion throughput was 4.37 lbs/hr (1.98 kg/hr). The extruded sheet was chilled on a cast roll. The overall sheet thickness was controlled at 30 mils (0.76 mm).

The film was then thermally formed into a dental tray. As summarized in Table 2 below, the resulting dental tray had poor folding crazing resistance.

### Comparative Example 6

10 mils TPU 65D film sample was obtained from Lubrizol, Wickliffe, Ohio, and 10 mils co-polyester film (PACUR HT) was obtained from Pacur, LLC, Oshkosh, Wis. A 3-layer ABA (HT/TPU 65D/HT) tray was prepared by layer-by-layer thermoforming process. As summarized in Table 2 below, the resulting dental tray had very poor interfacial adhesion.

### Comparative Example 7

A dental tray available from Align Technologies, San Jose, Calif., under the trade designation INVISALIGN SMARTTRACK, was tested. As summarized in Table 2 below, the tray had very poor stain resistance.

### Comparative Example 8

A single-layer polymeric film with 100% TX1000 resin was extruded through a film die using a pilot scale extruder at a throughput of 15 lbs/hr (22.7 kg/hr). The extrusion melt temperature was controlled to be 550° F. (288° C.). The extruded sheet thickness was controlled at 30 mils (0.76 mm). The film was then subsequently thermally formed into a dental tray. As summarized in Table 2 below, the dental tray of single-layer TX1000 has poor crack resistance.

### Comparative Example 9

A single-layer polymeric film with 100% MX730 resin was extruded through a film die using a pilot scale extruder at a throughput of 15 lbs/hr (22.7 kg/hr). The extrusion melt temperature was controlled to be 536° F. (276.7° C.). The extruded sheet thickness was controlled at 30 mils (0.76 mm). The film was then subsequently thermally formed into a dental tray. As summarized in Table 2 below, the dental tray of single-layer MX730 has poor crack resistance.

### Comparative Example 10

A 5-layer CBABC (TX2000/NEOSTAR/TX2000/NEOSTAR/TX2000) film was extruded using a pilot scale coextrusion line equipped with a feedblock and film die. The skin layer (C) extruder was fed with the first rigid resin, TX2000. The skin layer (C) extrusion melt temperature was controlled at 541° F. (282.8° C.). The throughput was 6.3 lbs/hr (2.86 kg/hr). The core layer (A) extruder was also fed with the first rigid resin, TX2000, and the extrusion melt temperature was controlled at 562° F. (294.4° C.). The core layer extrusion throughput was 11.59 lbs/hr (5.26 kg/hr). The middle layer (B) extruder was fed with a second thermoplastic elastomeric resin, NEOSTAR, and the extrusion temperature was controlled at 399° F. (203.9° C.). The middle layer extrusion throughput was 5.6 lbs/hr (2.54 kg/hr). The extruded sheet was chilled on a cast roll and had an average haze of 3.3% and transmission of 89%. The overall sheet thickness was controlled at 30 mils (0.76 mm).

The film was then subsequently thermal formed into a dental tray. As summarized in Table 2 below, the resulting dental tray had poor crack resistance.

### Comparative Example 11

A 5-layer CBABC (MX710/ECDEL/MX710/ECDEL/MX710) film was extruded using a pilot scale coextrusion line equipped with a feedblock and film die. The skin layer (C) extruder was fed with the first rigid resin, MX710. The skin layer (C) extrusion melt temperature was controlled at 524° F. (273.3° C.). The throughput was 56.34 lbs/hr (25.56 kg/hr). The core layer (A) extruder was also fed with the first rigid resin, MX710, and the extrusion melt temperature was controlled at 547° F. (286.1° C.). The core layer extrusion throughput was 141 lbs/hr (63.96 kg/hr). The middle layer (B) extruder was fed with a second thermoplastic elastomeric resin, ECDEL, and the extrusion temperature was controlled at 414° F. (212.2° C.). The middle layer extrusion throughput was 53.95 lbs/hr (24.47 kg/hr). The extruded sheet was chilled on a cast roll and had an average haze of 1.6% and transmission of 90.3%. The overall sheet thickness was controlled at 25 mils (0.625 mm). The film was then subsequently thermal formed against a flat mold. The maximum thermal forming temperature of the heated film was measured 240° C. by the IR thermometer. The haze of the thermoformed article was determined to be 21%.

TABLE 2

| | | | | Aligner Tray | | | |
|---|---|---|---|---|---|---|---|
| | | | DMA | On/Off | | | |
| | | | Stress | Cycling Crack | | | |
| | | | Relaxation | Resistance | Staining | | Folding |
| | | | at 95% | Test (# of | Resistance | Interfacial | Crazing |
| | Modulus | | RH | cycle to break) | to coffee | Adhesion | Resistance |
| Example 1 | 1.23 | GPa | 31.95% | ≥450 | Good | Pass | Good |
| Example 2 | 1.21 | GPa | 32.80% | ≥450 | Good | Pass | Good |
| Example 3 | N/A | | N/A | ≥450 | Good | Pass | Good |
| Comparative | 2.1 | GPa | 41.7% | 333 | Good | N/A | N/A |
| Example 1 | | | | | | | |
| Comparative | 1.2 | GPa | 45.60% | N/A | Good | Pass | Good |
| Example 2 | | | | | | | |
| Comparative | 1.47 | GPa | 26.20% | <10 | Good | N/A | Poor |
| Example 3 | | | | | | | |
| Comparative | N/A | | N/A | N/A | N/A | Fail | N/A |
| Example 4 | | | | | | | |
| Comparative | 1.22 | GPa | N/A | N/A | N/A | N/A | Poor |
| Example 5 | | | | | | | |

| | | | | | | |
|---|---|---|---|---|---|---|
| Comparative | N/A | N/A | N/A | N/A | Fail | N/A |
| Example 6 | | | | | | |
| Comparative | N/A | N/A | N/A | Poor | N/A | N/A |
| Example 7 | | | | | | |
| Comparative | N/A | N/A | 87 | N/A | N/A | N/A |
| Example 8 | | | | | | |
| Comparative | N/A | N/A | <10 | N/A | N/A | N/A |
| Example 9 | | | | | | |
| Comparative | N/A | N/A | 81 | N/A | N/A | N/A |
| Example 10 | | | | | | |

Various embodiments of the invention have been described. These and other embodiments are within the scope of the following claims.

1. A dental appliance for positioning a patient's teeth, the dental appliance comprising:
a polymeric shell comprising a plurality of cavities for receiving one or more teeth, wherein the polymeric shell comprises:
(1) an interior region with at least 3 alternating layers, wherein the interior region comprises: a core layer with a first major surface and a second major surface, wherein the core layer comprises a first thermoplastic polymer A with a thermal transition temperature of about 70° C. to about 140° C. and a flexural modulus greater than about 1.3 GPa;
a first interior layer adjacent to the first major surface of the core layer; and
a second interior layer adjacent to the second major surface of the core layer;
wherein the first interior layer and the second interior layer, which may be the same or different, comprise a second thermoplastic polymer B different from the first thermoplastic polymer A, wherein the second thermoplastic polymer B has a glass transition temperature of less than about 0° C. and a flexural modulus less than about 1 GPa; and
(2) an exterior region, comprising:
a first exterior layer on a first side of the interior region, and
a second exterior layer on a second side of the interior region,
wherein the first exterior layer and the second exterior layer, which may be the same or different, comprise a third thermoplastic polymer C, which may be the same or different than the first thermoplastic polymer A, with a thermal transition temperature of about 70° C. to about 140° C. and a flexural modulus greater than about 1.3 GPa; and
wherein an interfacial adhesion between any of the adjacent layers in the polymeric shell is greater than about 150 grams per inch (6 grams per mm).

2. The dental appliance of claim 1, wherein the third thermoplastic polymer C in the first and the second exterior layers is the same as the first thermoplastic polymer A in the core layer.

3. The dental appliance of claim 2, and wherein the first and the second interior layers comprise the same thermoplastic polymer B.

4. The dental appliance of claim 1, wherein the polymeric shell comprises 5 layers, and wherein the third thermoplastic polymer C in the first and the second exterior layers is the same as the first thermoplastic polymer A in the core layer, and wherein the first and the second interior layers comprise the same thermoplastic polymer B.

5. The dental appliance of claim 1, wherein a difference in a solubility parameter between any two adjacent layers in the polymeric shell is no greater than about 2.

6. The dental appliance of claim 1, wherein the polymeric shell has an effective modulus of about 0.8 GPa to about 1.5 GPa.

7. The dental appliance of claim 1, wherein the third thermoplastic polymer C in the first and the second exterior layers comprises a polyester or a copolyester, wherein the third thermoplastic polymer C is chosen from polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedimethylene) terephthalate; (PCTA), 2,2,4,4-tetramethyl-1,3-cyclobutanediol modified polycyclohexylenedimethylene terephthalate, polyesters, copolyesters, and mixtures and combinations thereof, and wherein the first thermoplastic polymer A in the core layer comprises a polyester or a copolyester, wherein the first thermoplastic polymer A is chosen from polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedimethylene) terephthalate (PCTA), 2,2,4,4-tetramethyl-1,3-cyclobutanediol modified polycyclohexylenedimethylene terephthalate, polyesters, copolyesters, and mixtures and combinations thereof.

8. (canceled)

9. The dental appliance of claim 7, wherein the first thermoplastic polymer A is chosen from copolyesters, and wherein the copolyesters are free of ethylene glycol, and wherein the second thermoplastic polymers B comprise at least one of copolyester ether elastomers and ethylene methyl-acrylates.

10. The dental appliance of claim 1, wherein the second thermoplastic polymers B in the first and the second interior layers are independently chosen from copolyester ether elastomers, copolymers of ethylene and (meth)acrylates, ethylene methyl-acrylates, ethylene ethyl-acrylates, ethylene butyl acrylates, maleic anhydride modified polyolefin copolymers, methacrylic acid modified polyolefin copolymers, ethylene vinyl alcohol (EVA) polymers, styrenic block copolymers, ethylene propylene copolymers, and thermoplastic polyurethanes (TPU).

11. (canceled)

12. The dental appliance of claim 1, wherein at least one of the first exterior layer and the second exterior layer comprises on an external major surface thereof a polymeric moisture barrier layer, the polymeric moisture barrier layer comprising a polyolefin, wherein the polyolefins are chosen from polyethylene (PE), polypropylene (PP), polymethylpentene (PMP), cyclic olefins (COP), copolyolefins with moieties chosen from ethylene, propylene, butene, pentene, hexene, octene, C2-C20 hydrocarbon monomers with polymerizable double bonds, and mixtures and combinations thereof; and olefin hybrids chosen from olefin/anhydride, olefin/acid, olefin/styrene, olefin/acrylate, and mixtures and combinations thereof.

13. The dental appliance of claim 1, wherein the thermoplastic polymers A and C have an elongation at break of greater than 100%, and wherein the thermoplastic polymers B have an elongation at break of greater than 300%.

14. A method of making a dental appliance, the method comprising:
forming a plurality of tooth-retaining cavities in a multilayered polymeric film to provide the dental appliance, the multilayered polymeric film comprising:
(1) an interior region with at least 3 alternating layers, wherein the interior region comprises:
a core layer with a first major surface and a second major surface, wherein the core layer comprises a first thermoplastic polymer A with a thermal transition temperature of about 70° C. to about 140° C. and a flexural modulus greater than about 1.3 GPa;
a first interior layer adjacent to the first major surface of the core layer;
a second interior layer adjacent to the second major surface of the core layer;
wherein the first interior layer and the second interior layer, which may be the same or different, comprise a second thermoplastic polymer B different from the first thermoplastic polymer A, wherein the second thermoplastic polymer B has a thermal glass temperature of less than about 0° C. and a flexural modulus less than about 1 GPa; and
(2) an exterior region, comprising:
a first exterior layer on a first side of the interior region, and
a second exterior layer on a second side of the interior region,
wherein the first exterior layer and the second exterior layer, which may be the same or different, comprise a third thermoplastic polymer C, which may be the same or different than the first thermoplastic polymer A, with a thermal transition temperature of about 70° C. to about 140° C. and a flexural modulus greater than about 1.3 GPa; and
wherein an interfacial adhesion between any of the adjacent layers in the multilayer film is greater than about 150 grams per inch (6 grams per mm).

15. The method of claim 14, wherein the first and the second exterior layers comprise the same thermoplastic polymer C, and wherein the first exterior layer, the second exterior layer, and the core layer comprise the same thermoplastic polymer A.

16. The method of claim 14 or 15, wherein the thermoplastic polymers in the first and the second exterior layers and the core layer comprise a polyester or a copolyester, which may be the same or different, wherein the polyester is independently chosen from polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedimethylene) terephthalate (PCTA), 2,2,4,4-tetramethyl-1,3-cyclobutanediol modified polycyclohexylenedimethylene terephthalate, polyesters, copolyesters, and mixtures and combinations thereof, and wherein the second thermoplastic polymers B in the first and the second interior layers are independently chosen from copolyester ether elastomers, copolymers of ethylene and (meth)acrylates, ethylene methyl-acrylates, ethylene ethyl-acrylates, ethylene butyl acrylates, maleic anhydride modified polyolefin copolymers, methacrylic acid modified polyolefin copolymers, ethylene vinyl alcohol (EVA) polymers, styrenic block copolymers, ethylene propylene copolymers, and thermoplastic polyurethanes (TPU).

17. (canceled)

18. The method of claim 16, wherein the second thermoplastic polymers B comprise copolyester ether elastomers.

19-20. (canceled)

21. A dental appliance for positioning a patient's teeth, comprising:
a polymeric shell comprising a plurality of cavities for receiving one or more teeth, wherein the polymeric shell comprises:
a core region, comprising:
a core layer with a first major surface and a second major surface, wherein the core layer comprises at least one layer of a thermoplastic polymer A with a thermal transition temperature of about 70° C. to about 140° C. and a flexural modulus greater than about 1.3 GPa; and
an internal layer on the first major surface and the second major surface of the core layer, wherein the internal layers, which may be the same or different, each comprise at least one layer of a thermoplastic polymer B different from the thermoplastic polymer A, and wherein the thermoplastic polymer B has a glass transition temperature of less than about 0° C. and a flexural modulus less than about 1 GPa; and
external surface layers on each side of the core region, wherein the external surface layers, which may be the same or different, each comprise at least one layer of a thermoplastic polymer C, different from the thermoplastic polymer A, wherein the thermoplastic polymer C has a thermal transition temperature of about 70° C. to about 140° C. and a flexural modulus greater than about 1.3 GPa; and
wherein an interfacial adhesion between any of the adjacent layers in the polymeric shell is greater than about 150 grams per inch (6 grams per mm).

22. The dental appliance of claim 21, wherein the core layer of the dental appliance comprises a single layer of the thermoplastic polymer A.

23. The dental appliance of claim 21, wherein at least some of the internal layers comprise a single layer of the thermoplastic polymer B.

24. The dental appliance of claim 21, wherein the second thermoplastic polymer B has a Vicat softening temperature of greater than 65° C.

25. (canceled)
